(19) United States
(12) Patent Application Publication
(10) Pub. No.: US 2011/0075438 A1
(43) Pub. Date: Mar. 31, 2011

(54) LED LIGHT SOURCE AND VEHICLE LIGHT

(76) Inventors: Sachio SHIRAI, Tokyo (JP); Manami Sano, Tokyo (JP)

(21) Appl. No.: 12/895,766

(22) Filed: Sep. 30, 2010

(30) Foreign Application Priority Data
Sep. 30, 2009 (JP) 2009-226595

(51) Int. Cl. B60Q 1/04; F21S 4/00

(52) U.S. Cl. 362/538; 362/249.02

(57) ABSTRACT

An LED light source can include a radiating substrate, a sub mount substrate, at least one white LED and a side wall. The sub mount substrate can be mounted on the radiating substrate, and the at least one white LED can be mounted on the sub mount substrate. The side wall can be mounted on the radiating substrate so as to face the at least one white LED. The side wall can be configured with a black mat material and, therefore, can absorb an upward light that may give a glaring type light to an oncoming car and the like. The number of the white LED and a shape of the side wall can be selected in accordance with a particular type of vehicle to match various headlights. Thus, a vehicle headlight using the LED light source can provide a favorable light distribution without the glaring type light for various vehicles.

This application claims the priority benefit under 35 U.S.C. §119 of Japanese Patent Application No. 2009-226595 filed on Sep. 30, 2009, which is hereby incorporated in its entirety by reference.

### BACKGROUND

1. Field

The presently disclosed subject matter relates to an LED light source and a vehicle light including the LED light source, and more particularly to a vehicle headlight having a favorable light distribution pattern, in which the LED light source can prevent the light from giving a glaring type light to an oncoming car, truck and the like.

2. Description of the Related Art

Recently, various LED light sources have been used as a light source for a vehicle headlight because of certain merits, such as long life, low-power consumption, etc. The vehicle headlight using an LED light source can illuminate light emitted from the LED light source to form a prescribed light distribution pattern. For example, the vehicle headlight may illuminate the light emitted from the LED light source in a front and downward direction thereof as a low beam while the LED light source prevents the light from causing an upward light that may give a glaring type light to an oncoming car and the like.

LED light sources including a beam shutter that may prevent the upward light are disclosed in patent document No. 1 (Japanese Patent Application Laid Open JP2006-222430), patent document No. 2 (Japanese Patent Application Laid Open JP2007-103937), patent document No. 3 (Japanese Patent Application Laid Open JP2008-507850), etc. FIG. 6 is a cross-section view showing a conventional LED light source including the beam shutter, which is disclosed in patent document No. 1.

The conventional LED light source includes: a circuit board 28 including conductor patterns 26 on a surface thereof; a sub mount substrate 24 mounted on the conductor patterns 26 of the circuit board 28; an LED chip 20 mounted on the sub mount substrate 24; a phosphor resin 22 covering the LED chip 20; and a beam shutter 30 shielding light emitted from the LED chip 20 within the range of a beam line 31. Therefore, the beam shutter 30 may shield an upward light by reflecting light that is emitted from the LED chip 20 toward the beam shutter 30 within the range of the beam line 31.

When the LED light source is used for a vehicle headlight, an LED light source array as shown in FIG. 7 is also disclosed in patent document No. 1. The LED light source array 34 is composed of a plurality of the LED light sources that includes the LED chips 20-1, 20-2, - - - , 20-N and the beam shutters 30-1, 30-2, - - - , 30-N to increase a brightness of the LED light source. A vehicle headlight using the LED light source array 34 may be constructed by locating a projector lens in front of the LED light source array 34.

In this case, the beam shutter 30-1 may prevent the LED chip 20-1 from causing an upward light, which may give a glaring type light to an oncoming car, etc. However, as shown by dashed lines in FIG. 7, light reflected on the beam shutter 30-1 may be reflected on a top surface of the beam shutter 30-3, and therefore may become an upward light. In addition, direct light emitted from the LED chip 20-1 may be reflected on a top surface of the beam shutter 30-4, and thereby may change another upward light.

When the vehicle headlight is constructed by only one LED light source including the LED chip 20-1 and the beam shutter 30-1 and the projector lens that is located in front of the LED light source, the light reflected by the beam shutter 30-1 may be reflected on a lens holder for attaching the projector lens, and therefore the light may be redirected into an upward light. Thus, the conventional beam shutter may not perfectly prevent the light from causing a glaring type light.

FIG. 8 is a cross-section view depicting another conventional LED light source, which is disclosed in patent document No. 4 (Japanese Utility Model Patent Application Laid Open H05-50754). The other conventional LED light source includes: first and second lead frames 42, 43; an LED chip 41 having a bottom electrode and a top electrode mounted on the first lead frame 42, the bottom electrode thereof electrically connected to the first lead frame 42 and the top electrode thereof electrically connected to the second lead frame 43 via a wire bonding 44; a black resin 46 having a low reflectivity factor covering the first and the second lead frames 42 and 43 except for a peripheral portion of the LED chip 41; and a transparent resin 47 covering the LED chip 41 including the peripheral portion.

In the above-described LED light source, if light emitted from the LED chip 41 is reflected on a boundary surface of the transparent resin 47, the reflected light may not be reflected back by the black resin 46 due to the low reflectivity factor. Accordingly, a directional characteristic of the conventional LED light source may be improved, and therefore such a conventional LED light source may prevent the conventional vehicle headlight from giving a glaring type light to an oncoming car and the like.

The above-referenced Patent Documents are listed below and are hereby incorporated with their English abstracts in their entirety.
1. Patent document No. 1: Japanese Patent Application Laid Open JP2006-222430
2. Patent document No. 2: Japanese Patent Application Laid Open JP2007-103937
3. Patent document No. 3: Japanese Patent Application Laid Open JP2008-507850
4. Patent document No. 4: Japanese Utility Model Patent Application Laid Open H05-50754
5. Patent document No. 5: U.S. patent application Ser. No. 12/391,228, U.S. Patent Publication No. US 2009/0257240 A1

However, in the conventional LED light source that is disclosed in patent document No. 4, when light emitted from the LED chip 41 is reflected on the peripheral portion of the LED chip 41, the light may not be controlled because the light can become a stray light due to reflective action by the peripheral portion which has a high reflectivity factor. Therefore, a vehicle headlight including the conventional LED light source may also give a glaring type light to an oncoming car, etc.

The disclosed subject matter has been devised to consider the above and other problems, characteristics and features. Thus, an embodiment of the disclosed subject matter can include an LED light source having a favorable directional characteristic that can prevent the light from giving a glaring type light to an oncoming car, truck and the like when the LED light source is used for a vehicle lamp. In this case, because the LED light source may include a plurality of LED chips, the LED light source can provide a favorable light distribution pattern as a light source for various vehicle headlights.

### SUMMARY

The presently disclosed subject matter has been devised in view of the above and other characteristics, desires, and problems in the conventional art, and to make certain changes to existing vehicle lamps, headlights, and projector headlights. Thus, an aspect of the disclosed subject matter includes providing an LED light source having a favorable directional characteristic, in which a side wall configured with a black mat (or matte) material can prevent the light source from causing an upward light that may give a glaring type light to an oncoming car and the like. Another aspect of the disclosed subject matter includes providing a vehicle headlight using the LED light source, which can result in a battery friendly headlight having a favorable light distribution pattern in accordance with certain types of vehicles. The light can be used for the various vehicles including an electric car and the like.

According to an aspect of the disclosed subject matter, an LED light source can include a radiating substrate having a mounting surface, a sub mount substrate having at least one LED mounting pad and at least one conductor pattern, at least one white LED including an LED chip and an optical axis and a side wall having an inner top edge. The sub mount substrate can be located on the mounting surface of the radiating substrate. The at least one white LED can be mounted on the at least one LED mounting pad of the sub mount substrate, and one of electrodes of the LED chip can be electrically connected to the at least one LED mounting pad, and another one of the electrodes can be electrically connected to the at least one conductor pattern of the sub mount substrate. In addition, the side wall can be configured with a black mat material and can be mounted on the mounting surface of the radiating substrate while it is located adjacent to at least a part of the sub mount substrate so that the at least one white LED faces the side wall.

In the above-described exemplary LED light source, the side wall can be formed in a tubular shape so as to surround the at least one white LED on the sub mount substrate, and can be configured with a thermal resistance material that mixes at least one of titanium carbide, a metallic powder and a carbon with aluminum oxide. The inner top edge of the side wall can project toward the optical axis of the at least one white LED to reduce a height of the side wall. The mounting surface of the radiating substrate that mounts the sub mount substrate can be formed in a concave shape. Moreover, a minimum angle of intersecting angles of the optical axis of the at least one white LED and imaginary lines that connect the LED chip of the at least one white LED to the inner top edge of the side wall can be between 65 degrees and 75 degrees.

In this case, the side wall can be configured with the black mat material that can absorb any unnecessary light such that may cause an unwanted upward light. In addition, the minimum intersecting angle of the optical axis of the at least one white LED and imaginary lines that connect the LED chip of the at least one white LED to the inner top edge of the side wall can be between 65 degrees and 75 degrees. Thus, the disclosed subject matter can provide an LED light source having a favorable directional characteristic between approximately −70 degrees and 70 degrees with respect to the optical axis without upward directed light that may give a glaring type light to an oncoming car, etc. Furthermore, the LED light source can be used as a light source for various headlights of vehicles by selecting the number of the LED chip.

According to another aspect of the disclosed subject matter, a vehicle headlight using a LED light source can include a shade for forming a horizontal cut-off line and a projector lens for projecting light emitted from the LED light source. The vehicle headlight can further include at least one reflector, wherein a first reflector is located substantially at the LED chip of the at least one white LED so that the side wall is located between the shade and the at least one white LED and so that the optical axis of the at least one white LED is directed toward the at least one reflector, and a second reflector is located substantially at the shade.

In the above-described vehicle headlight, light emitted from the LED light source having a favorable directional characteristic without upward light can be emitted from the optical lens. In addition, the vehicle headlight can cause illumination of a road with a prescribed light distribution patter via the optical lens to match the vehicle after reflecting the light emitted from the LED light source by the at least one reflector. Thus, the above-described light can provide a battery friendly headlight that can provide a favorable light distribution pattern with high efficiency and low power consumption, and can be used for various vehicles such as an electrical car and the like.

### BRIEF DESCRIPTION OF THE DRAWINGS

These and other characteristics and features of the disclosed subject matter will become clear from the following description with reference to the accompanying drawings, wherein:

FIG. 1 is a top view showing an exemplary embodiment of an LED light source made in accordance with principles of the disclosed subject matter;

FIG. 2 is a cross-section view showing the LED light source taken along line II-II shown in FIG. 1;

FIG. 3 is a diagram showing a directional characteristic of the LED light source shown in FIG. 2;

FIG. 4 is a cross-section view showing an exemplary variation of the LED light source of FIG. 2;

FIG. 5 is a schematic cross-section view of an exemplary embodiment of a vehicle headlight using the LED light source of FIG. 1;

FIG. 6 is a cross-section enlarged view depicting a conventional LED light source including a beam shutter;

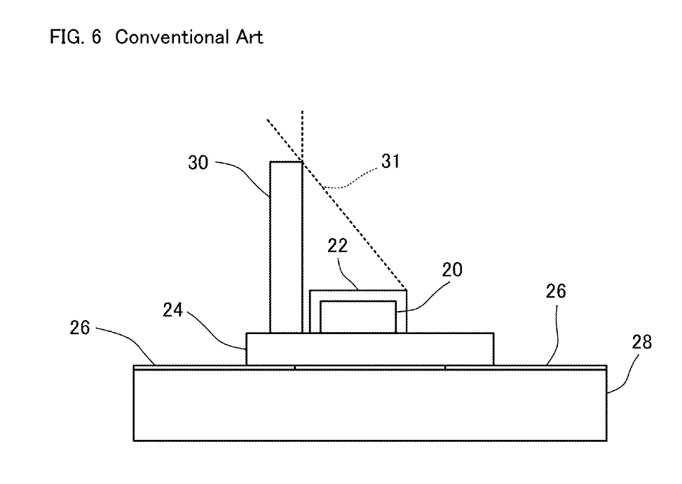

FIG. 7 is a schematic front view showing an LED light source array using the conventional LED light source of FIG. 6; and

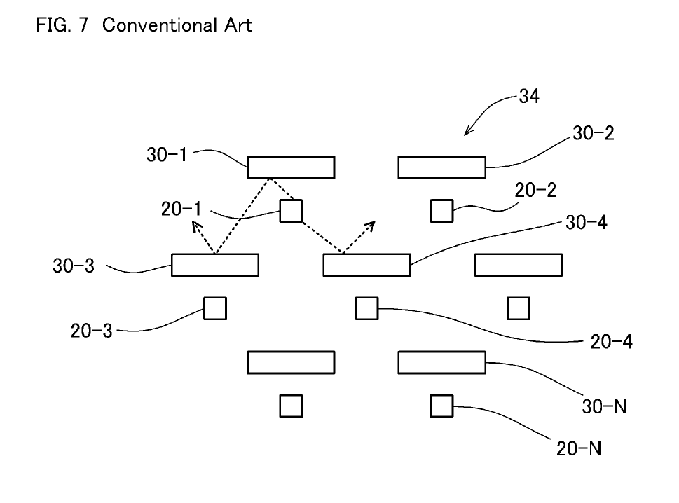

FIG. 8 is a cross-section view depicting another conventional LED light source.

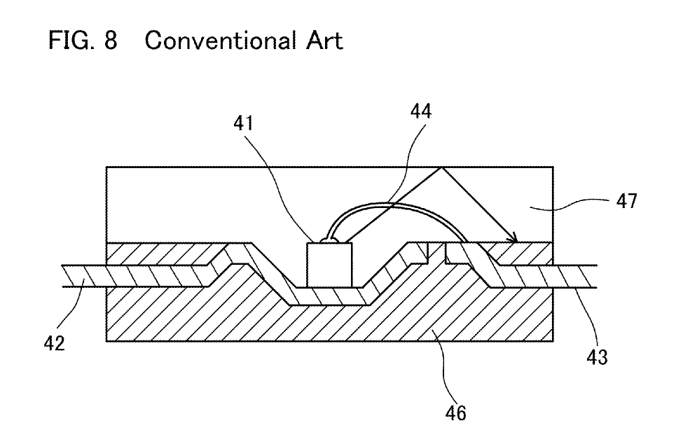

### DETAILED DESCRIPTION OF EXEMPLARY EMBODIMENTS

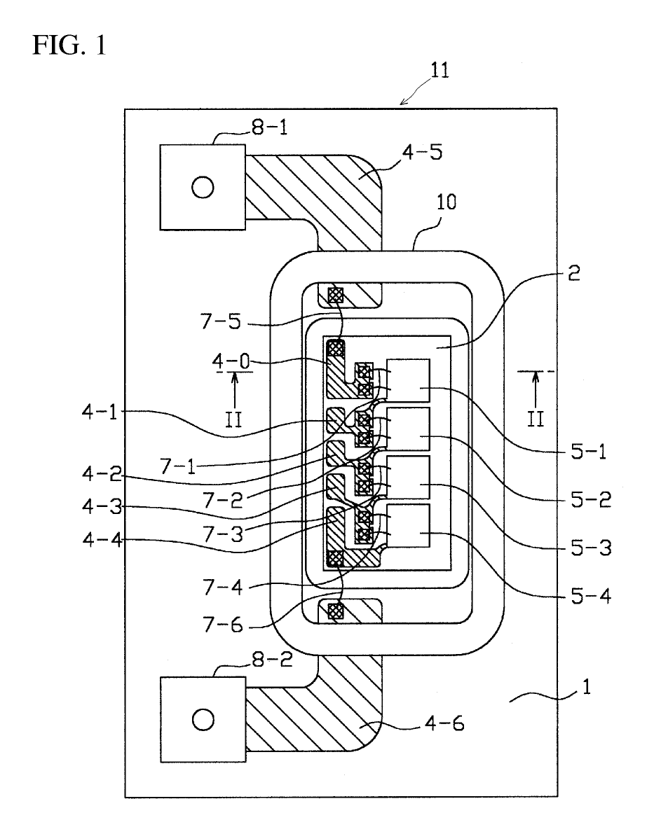

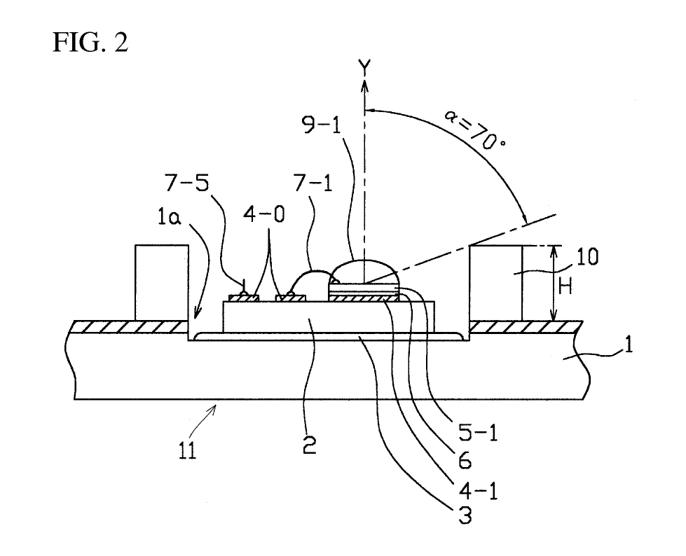

The disclosed subject matter will now be described in detail with reference to FIG. 1 to FIG. 5. FIG. 1 is a top view showing an exemplary embodiment of an LED light source made in accordance with principles of the disclosed subject matter. FIG. 2 is a cross-section view showing the LED light source taken along the line II-II shown in FIG. 1. The LED light source 11 can be used as a light source for a vehicle headlight.

The LED light source 11 can include a radiating substrate 1 that can be made of a copper plate, an aluminum plate or the like, and a sub mount substrate 2 that can be made of an aluminum nitride (AlN), or similar material. The radiating substrate 1 can include a concave portion 1a, and the sub mount substrate 2 can be attached onto the concave portion 1a of the radiating substrate 1 via a conductive adhesive material 3, which can be a solder (e.g. AuSn solder), or other known electrically conductive adhesive pastes, materials or structures. Thereby, the LED light source 11 can be miniaturized while the heat radiation efficiency thereof improves.

On the sub mount substrate 2, conductor patterns 4-0 to 4-4 can be formed thereon and can be made of a copper thin film or other known conductor pattern material(s). Four LED chips 5-1, 5-2, 5-3 and 5-4 can be mounted on the conductor patterns 4-1 to 4-4 via a solder 6 (e.g. AuSn solder) or other known electrically conductive adhesive pastes, materials or structures, while bottom electrodes thereof are electrically connected to the conductor patterns 4-1 to 4-4, respectively. When the LED light source 11 is used for a vehicle headlight, the vehicle headlight can illuminate a road with a wide range by aligning the LED chips 5-1 to 5-4.

On top surfaces of the LED chips 5-1 to 5-4, top electrodes can be provided. The top electrodes of the LED chips 5-1 to 5-4 can be electrically connected to the conductor patterns 4-0 to 4-3 via bonding wires 7-1, 7-2, 7-3 and 7-4, respectively. The conductor patterns 4-0 and 4-4 can be electrically connected to conductor patterns 4-5 and 4-6 via bonding wires 7-5 and 7-6, respectively. Couplers 8-1 and 8-2 can be respectively connected to the conductor patterns 4-5 and 4-6 in order to receive a power supply.

Consequently, the conductor patterns 4-1 to 4-4 can also be used as mounting pads for mounting the LED chips 5-1 to 5-4, and the conductor pattern 4-0 to 4-3 can be used as wire bonding pads. Thereby, the LED chips 5-1 to 5-4 can be connected in series so as to receive a power supply with the couplers 8-1 and 8-2.

When the LED chips 5-1 to 5-4 are blue LEDs (e.g. a GaN blue chip), mixture resins 9-1 to 9-4 (only 9-1 is shown in FIG. 2) that mixes a yellow phosphor (e.g. YAG:Ce) with a silicone resin can be applied to the LED chips 5-1 to 5-4 by a dispenser and the like. Therefore, the LED chips 5-1 to 5-4 can emit white light by an additive color mixture of the blue light and the yellow phosphor. In this case, the mixture resins 9-1 to 9-4 can be eliminated by using three color chips of a red LED, a blue LED and a green LED.

In the above-described structure, a reflectivity factor of the sub mount substrate 2 that is made of the aluminum nitride is approximately 40%. Accordingly, the sub mount substrate 2 may cause an upward light that may give a glaring type light to an oncoming car and the like due to the high reflectivity factor when the LED light source 11 is used for a vehicle headlight.

Therefore, a side wall 10 can be formed in a tubular shape such that the side wall 10 can surround the conductor patterns 4-1 to 4-4 and the LED chips 5-1 to 5-4 in order to absorb at least a portion of the upward light that is reflected from the sub mount substrate 2. In addition, the side wall 10 can protect the bonding wires 7-1 to 7-6 by surrounding the bonding wires 7-1 to 7-6. The side wall 10 can be dissymmetric with respect to the LED chips 5-1 to 5-4, but can also be symmetrical with respect to the LED chips 5-1 to 5-4. In addition, the side wall 10 itself can be symmetrical about a central longitudinal axis passing through the side wall 10, but can also be dissymmetrical about the central longitudinal axis and/or other axes.

More specifically, a distance between the LED chips 5-1 to 5-4 and the side wall 10 of an upward side that does not include the bonding wires 7-1 to 7-4 can be short. In contrast, a distance between the LED chips 5-1 to 5-4 and the side wall 10 of a downward side that includes the bonding wires 7-1 to 7-4 can be long as compared with the distance of the upward side. Accordingly, the side wall 10 can directly absorb an upward light of the upward side from light emitted from the LED chips 5-1 to 5-4.

A surface of the side wall 10 can be formed in a black mat surface that does not substantially reflect light emitted from the LED chips 5-1 to 5-4. Thereby, stray light may not be caused and therefore, the glaring type light can be avoided when the LED light source 11 is used for a vehicle headlight. In this case, a high thermal resistance of the side wall 10 can be used because operating junction temperatures of the LED chips 5-1 to 5-4 may become approximately 150 degrees centigrade.

Therefore, the side wall 10 can be made of a thermal resistance material that mixes titanium carbide (TiC), a metallic powder, a carbon and the like with aluminum oxide (Al₂O₃). A height H of the side wall 10 can be such that the side wall 10 can protect the bonding wires 7-1 to 7-6 from touching the bonding wires 7-1 to 7-6 during operation. However, when the height H of the side wall 10 is too tall, an amount of light emitted from the LED chips 5-1 to 5-4 may decrease due to the light-absorbing side wall 10. Consequently, the height H of the side wall 10 can be determined such that the bonding wires 7-1 to 7-6 cannot be seen as viewed from a front view of the side wall 10.

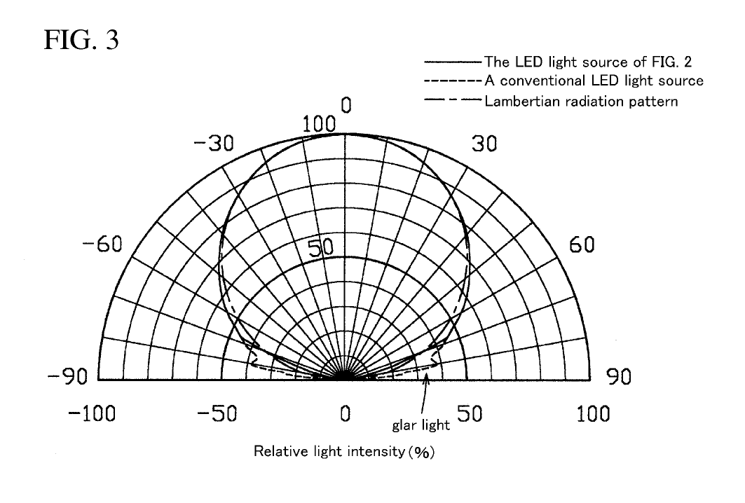

FIG. 3 is a diagram showing a directional characteristic of the LED light source shown in FIG. 2. Here, an optical axis Y of the LED chip 5-1 can correspond to 0 degree (a vertical direction in the diagram of FIG. 3). An intersection angle α of the optical axis Y and an imaginary line connecting a center of the LED chip 5-1 to an inner top end of the side wall 10 can be 70 degrees as shown in FIG. 2.

In this case, a directional characteristic of the LED light source 11 shown by a solid line in FIG. 3 can show a favorable light distribution pattern between −70 degrees and 70 degrees that is similar to a Lambertian radiation pattern, as shown by an alternate long and short dash line in FIG. 3. In contrast with the directional characteristic of the LED light source 11, a directional characteristic of an LED light source in which the side wall 10 is removed includes abnormal lights between −70 degrees and −90 degrees and between 70 degrees and 90 degrees as shown by a broken line in FIG. 3.

The abnormal light may cause an upwardly directed light that may give a glaring type light to an oncoming vehicle and the like when the LED light source without the side wall 10 is used for a vehicle headlight. Thus, it can be favorable for the above-described angle α to be approximately 70 degrees. When the angle α is smaller than 60 degrees having a relative light intensity of approximately 50%, the directional characteristic of the LED light source 11 may be different from the Lambertian radiation pattern shown by an alternate long and short dash line in FIG. 3, and the light use efficiency of the LED light source 11 may decrease due to the side wall 10.

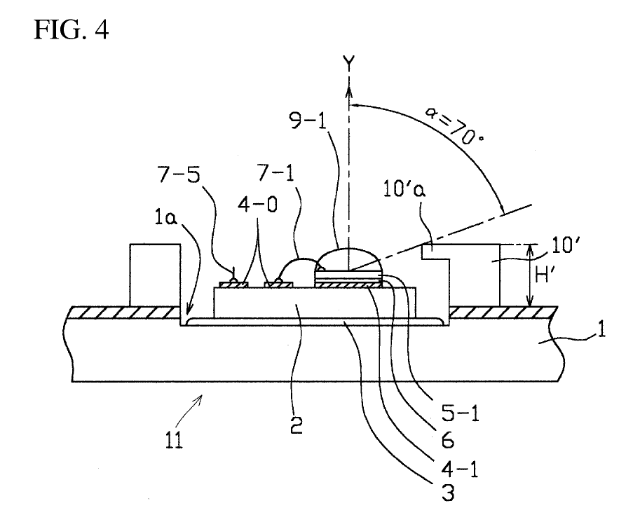

FIG. 4 is a cross-section view showing an exemplary variation of the LED light source of FIG. 2. A peaked side wall 10′ including a canopy 10′ a can be used in place of the side wall 10 in the LED light source 11 of FIG. 2. Thereby, while a height H′ of the peaked side wall 10′ is reduced, the favorable angle α of approximately 70 degrees can be maintained.

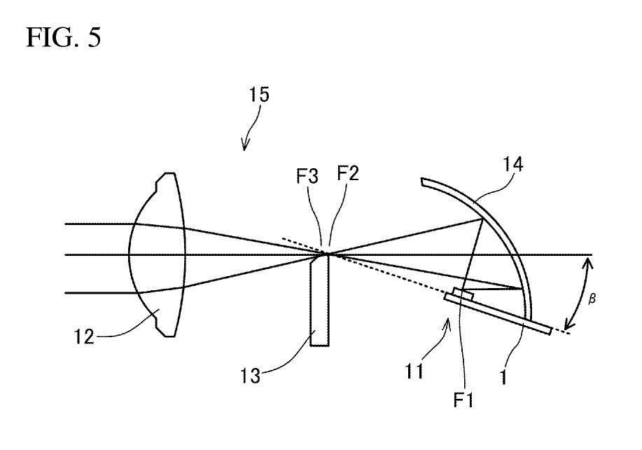

An exemplary vehicle headlight using the LED light source 11 will now be described. FIG. 5 is a schematic cross-section view of an exemplary embodiment of a vehicle headlight using the LED light source of FIG. 1. The vehicle headlight 15 can include: the LED light source 11; a reflector 14 for reflecting light emitted from the LED light source 11; a shade 13 for shielding a part of the light reflected by the reflector 14 to form a horizontal cut-off line; and a projector lens 12 for projecting light that is not shielded with the shade 13, wherein the projector lens 12 can include a convex lens having an optical axis and a focus F3 that is located on the optical axis.

The radiating substrate 1 of the LED light source 11 can be configured to decline (or reside at an angle with respect to the optical axis of the projector lens) in a direction opposed to and away from the projector lens 12. The projector lens 12 can have the focus F3 that intersects with a virtual extension of a mounting surface of the sub mount substrate 2. The angle β between a virtual extension of the mounting surface of the sub mount substrate 2 and the optical axis of the projector lens 12 can be configured within a predetermined range of 45 degrees or less at the focus located on the optical axis of the projector lens 12

Thus, a substantially right triangle can be configured with the optical axis of the projector lens 12, the mounting surface including the virtual extension of the sub mount substrate 2 and the optical axis Y of the LED chip 5-1. Two sides of the right triangle can be the mounting surface including the virtual extension of the sub mount substrate 2 and the optical axis Y of the LED chip 5-1, as shown in FIG. 4.

The reflector 14 can be configured with at least one ellipsoidal reflex surface, and a first focus F1 thereof can be located near the LED chip 5-1, and a second focus F2 of the reflector 14 can be located near the focus F3 of the projector lens 12. The reflector 14 can be located over a major linear axis passing through both the first focus F1 and the second focus F2. The linear axis can be configured to decline within the predetermined range of 45 degrees or less with respect to the optical axis of the projector lens 12. The reflector 14 can also be located above the LED chips 5-1 to 5-4. Thus, the reflector 14 can be formed as a half round having an opening for passing reflected light towards a front view thereof.

When the projector headlight 15 is used in low beam mode using the above-described structure, the projector headlight can include a shade 13 in order to shield an upward light that may give a glaring type of light to an oncoming car and the like. A top edge of the shade 13 can be located at or near the second focus F2 of the reflector 14 in order to form a horizontal cut-off line for an oncoming lane and a driving lane.

In this case, as shown in FIG. 3, the directional characteristic of the LED light source 11 can be located between −70 degrees and 70 degrees. If the side wall 10 is removed from the LED light source, light between −70 degrees and −90 degrees and between 70 degrees and 90 degrees may directly enter into the projector lens 12 without shielding by the shade 13. Accordingly, this direct light may cause the glaring type of light to an oncoming car and the like.

However, the LED light source 11 including the side wall 10 can allow the light between −70 degrees and 70 degrees to be directed toward the reflector 14 with high light use efficiency. Thus, the disclosed subject matter can provide the vehicle headlight 15 having a favorable light distribution pattern with a high efficiency and low power consumption with respect to the LED chips.

Various modifications of the above disclosed embodiments can be made without departing from the spirit and scope of the presently disclosed subject matter. For example, the above-described vehicle headlight 15 may not be limited to including the reflector 14. Instead, the light source 11 can be directed towards the projector lens 12 via the shade 13, or without the shade 13, as high beam mode in the vehicle headlight 15.

While there has been described what are at present considered to be exemplary embodiments of the invention, it will be understood that various modifications may be made thereto, and it is intended that the appended claims cover such modifications as fall within the true spirit and scope of the invention. All conventional art references described above are herein incorporated in their entirety by reference.

1. An LED light source, comprising:
a first substrate having a mounting surface that is formed in a flat shape;
a sub mount substrate having at least one LED mounting pad and at least one conductor pattern, and the sub mount substrate being located on the mounting surface of the first substrate;
at least one white LED including an LED chip and an optical axis, the at least one white LED located on the at least one LED mounting pad of the sub mount substrate, the LED chip including electrodes, one of the electrodes of the LED chip being electrically connected to the at least one LED mounting pad of the sub mount substrate, another one of the electrodes being electrically connected to the at least one conductor pattern of the sub mount substrate, and the optical axis intersecting with the LED chip; and
a side wall having an inner top edge configured with a black material, the side wall located on the mounting surface of the first substrate while the side wall is located adjacent to at least a part of the sub mount substrate so that the at least one white LED faces the side wall.

2. The LED light source according to claim 1, wherein the side wall is formed in a tubular shape so as to surround the at least one white LED on the sub mount substrate.

3. The LED light source according to claim 1, wherein the side wall is configured with a thermal resistance material that includes a mix of at least one of titanium carbide, a metallic powder and a carbon with aluminum oxide, the inner top edge of the side wall configured with a black mat material.

4. The LED light source according to claim 2, wherein the side wall is configured with a thermal resistance material that includes a mix of at least one of titanium carbide, a metallic powder and a carbon with aluminum oxide.

5. The LED light source according to claim 1, wherein the mounting surface of the first substrate is formed in a concave shape and the first substrate is a radiating substrate.

6. The LED light source according to claim 2, wherein the mounting surface of the first substrate is formed in a concave shape.

7. The LED light source according to claim 1, wherein a minimum angle of intersection between the optical axis of the at least one white LED and imaginary lines that connect the LED chip of the at least one white LED to the inner top edge of the side wall is between 65 degrees and 75 degrees.

8. The LED light source according to claim 2, wherein a minimum angle of intersection between the optical axis of the at least one white LED and imaginary lines that
connect the LED chip of the at least one white LED to the inner top edge of the side wall is between 65 degrees and 75 degrees.

9. The LED light source according to claim 1, wherein the inner top edge of the side wall includes a projection that projects toward the optical axis of the at least one white LED.

10. The LED light source according to claim 2, wherein the inner top edge of the side wall includes a projection that projects toward the optical axis of the at least one white LED.

11. A projector headlight, comprising:
a first substrate having a concave portion and a mounting surface, and each of the concave portion and mounting surface includes a flat surface, the concave portion being surrounded by the mounting surface;
a sub mount substrate having a plurality of LED mounting pads and a plurality of wire bonding pads, the sub mount substrate being located on the concave portion of the first substrate, the plurality of LED mounting pads being aligned, and each of the wire bonding pads being located adjacent to a respective one of the LED mounting pads;
a plurality of white LEDs, at least one of the white LEDs being located on each of the plurality of LED mounting pads, each of the white LEDs including a blue LED chip, a yellow phosphor resin and an optical axis, each blue LED chip including electrodes, one of the electrodes of the blue LED chip in each of the white LEDs being electrically connected to a respective one of the LED mounting pads of the sub mount substrate, another one of the electrodes of the blue LED chip in each of the white LEDs being electrically connected to a respective one of the wire bonding pads of the sub mount substrate, the yellow phosphor resin in each of the white LEDs covering a respective blue LED chip, and the optical axis of each of the white LEDs intersecting with a respective blue LED chip; and
a side wall having an inner top edge configured with a black material, the side wall located on the mounting surface of the first substrate and formed in a tubular shape so as to surround the plurality of white LEDs on the sub mount substrate.

12. The LED light source according to claim 11, wherein the side wall is configured with a thermal resistance material that includes a mix of at least one of titanium carbide, a metallic powder and a carbon with aluminum oxide, the inner top edge of the side wall configured with a black mat material.

13. The LED light source according to claim 11, wherein a minimum angle of intersection between the optical axis of one of the plurality of white LEDs and imaginary lines that connect the LED chip of the one of the white LEDs to the inner top edge of the side wall is between 65 degrees and 75 degrees.

14. The LED light source according to claim 12, wherein a minimum angle of intersection between the optical axis of one of the plurality of white LEDs and imaginary lines that connect the LED chip of the one of the white LEDs to the inner top edge of the side wall is between 65 degrees and 75 degrees.

15. A vehicle headlight including the LED light source according to claim 1, further comprising:
a shade located adjacent the at least one white LED; and
a projector lens located adjacent the shade.

16. The vehicle headlight according to claim 15, further comprising:
at least one reflector, wherein a first focus of the at least one reflector is located substantially at the LED chip of the at least one white LED so that the side wall is located between the shade and the at least one white LED and so that the optical axis of the at least one white LED is directed toward the at least one reflector, and a second focus of the at least one reflector is located substantially at the shade.

17. A vehicle headlight including the LED light source according to claim 2, further comprising:
a shade located adjacent the at least one white LED; and
a projector lens located adjacent the shade.

18. The vehicle headlight according to claim 1, further comprising:
at least one reflector, wherein a first focus of the at least one reflector is located substantially at the LED chip of the at least one white LED so that the optical axis of the at least one white LED is directed toward the at least one reflector, and a second focus of the at least one reflector is located substantially at the shade.

19. A vehicle headlight including the LED light source according to claim 11, further comprising:
at least one shade located adjacent at least one of the plurality of white LEDs; and
a projector lens located adjacent the at least one shade.

20. The vehicle headlight according to claim 19, further comprising:
at least one reflector, wherein a first focus of the at least one reflector is located adjacent the blue LED chip of a respective one of the plurality of white LEDs so that the optical axes of the plurality of white LEDs are directed toward the at least one reflector, and a second focus of the at least one reflector located substantially at the shade.
